(19) United States
(12) Patent Application Publication
(10) Pub. No.: US 2014/0286695 A1
(43) Pub. Date: Sep. 25, 2014

(54) CORNER REINFORCEMENT INSERT

(71) Applicant: C E S CONTROL ENCLOSURE SYSTEM GMBH, Bad Homburg V.d. Hoehe (DE)

(72) Inventors: Simon Jocham, Muenchen (DE); Paul Mazura, Karlsbad (DE); Walter Nicolai, Buseck (DE); Igor H. Schaaf, Rheinmuenster (DE)

(73) Assignee: C E S CONTROL ENCLOSURE SYSTEMS GMBH, Bad Homburg V.d. Hoehe (DE)

(21) Appl. No.: 14/354,619

(22) PCT Filed: Oct. 25, 2012
(86) PCT No.: PCT/EP2012/004472

§ 371 Date: Apr. 28, 2014

(30) Foreign Application Priority Data
Oct. 27, 2011 (DE) 10 2011 117 259.2

(51) Int. Cl. F16B 12/44

(52) U.S. Cl. CPC F16B 12/44
USPC 403/205

(57) ABSTRACT

The present disclosure relates to a corner reinforcement insert for wall elements having a double-angled edge, including a base part having a plate-shaped corner flange that is arranged at least substantially in a plane and has an angled inner circumferential edge and an angled outer circumferential edge and having a first web and a second web that extend from the same side of the base part on the inner circumferential edge of the corner flange perpendicularly to the corner flange plane and in parallel with the inner circumferential edge, wherein the first web is located on the side of a bending point of the inner circumferential edge and the second web is located on the other side of the bending point.

The invention relates to a corner reinforcement insert. A corner reinforcement insert is intended for components which consist of relatively thin, panel-shaped material and have a double-angled edge, i.e. an edge which is produced as a result of the fact that the panel-shaped material is bent twice by at least about 90 degrees in the same direction. Components of the aforesaid kind may be, for example, wall elements made of flat sheet metal, which are used, for example, in industrial furniture such as racks, cabinets including, in particular, switch cabinets, but also as covering parts. A wall element may also be a door, for example a sheet-metal door for a cabinet or the like. Instead of sheet metal, such wall elements may also be manufactured from plastic.

Components and, in particular, wall elements of the kind described have their stability, in particular their torsional stability, imparted to them above all by the double-angled edge, since the thin sheet-metal or plastic material that occupies the majority of their area does not have, as such, good torsional stiffness. Although the double-angled edge considerably enhances the torsional stiffness of such components, it is nevertheless desirable, particularly in the case of fairly large components, to further enhance the torsional stiffness without markedly increasing the weight of the component as a whole.

For the purpose of solving this problem, the present invention makes available a corner reinforcement insert which has the features in Patent Claim 1. Such a corner reinforcement insert is intended for insertion in the cavity which is formed in a corner region of a component of the aforesaid kind by the double-angled edge. A corner reinforcement insert according to the invention comprises a base part and a corner-shaped sheathing part. The term “corner-shaped” is to be understood as meaning that the basic shape of the sheathing part corresponds to the shape of the corner region in which the corner reinforcement insert is to be insertable. Such a corner need not necessarily have an angle of 90 degrees, but may also form a smaller or larger angle. The base part, which may also be characterized as the core of the corner reinforcement insert according to the invention, has a plate-shaped corner flange which is arranged, at least substantially, in one plane and has an angled inner circumferential edge and an angled outer circumferential edge. On the inner circumferential edge of the corner flange, a first web and a second web protrude on one and the same side of the base part, perpendicularly to the plane of the corner flange. The two webs extend parallel to the inner circumferential edge, the first web being located on said side of a bending point of the inner circumferential edge and the second web being located on the other side of the bending point. The sheathing part has a slot which is designed to accommodate the plate-shaped corner flange. When the corner flange is arranged in the sheathing part, said sheathing part surrounds the plate-shaped corner flange substantially completely, the first web and second web forming a stop for the sheathing part. While the base part consists of a material which is rigid relative to the sheathing part, in order to impart stability to the corner reinforcement insert, the sheathing part is manufactured from an elastically flexible material, for example an elastomer material, which is also used for seals.

Such a corner reinforcement insert, which is pushed with only slight clearance, and preferably no clearance at all, into a corner region of a double-angled edge not only distinctly enhances the torsional stiffness of the component because of the possibility of laminar support, which exists on both sides of the sheathing part, for the corresponding sections of the component having the double-angled edge, but is able, in addition, to effectively seal the corner region against the penetration of moisture or other unwanted environmental influences. The result, particularly in the case of wall elements which are produced from flat sheet metal, is slots in corner regions which conventionally could only be reliably closed by welding, bonding or the application of a bead of sealing material. By means of the corner reinforcement insert according to the invention, this is now possible in a simpler manner, said corner reinforcement insert preferably having a slight oversize which results, when it is in the inserted condition, in a light press fit which improves the sealing action.

The two webs preferably protrude sufficiently far from the corner flange that they not only form a stop for the sheathing part but protrude beyond the latter so as to be able to serve as a mechanical stop belonging to the corner reinforcement insert, which stop is able to interact with the free edge of the double-angled edge of the component. A corner reinforcement insert which is designed in such a way is then simply inserted in the corner region of a component until the two webs abut against the free edge of the double-angled edge.

The two webs may be separated from one another; however they are preferably connected to one another at the bending point of the inner circumferential edge and then form, as a whole, an angled web. According to one preferred form of embodiment, a positioning projection extends, in a direction perpendicular to the plane of the corner flange, from the webs at the bending point which are connected to one another in this way. The positioning projection protrudes still further than the two webs and serves, among other things, to facilitate the insertion of components provided with corner reinforcement inserts according to the invention in their installation position. Furthermore, such a positioning projection may act as a spacer when a number of components of the same kind are stacked on top of one another, in order, for example, to prevent said components from rubbing against one another in the course of transport, something which could otherwise lead to damage to the surface finish. The action as a spacer may also be advantageous when painting components which are stacked on top of one another.

In a particularly preferred manner, the aforesaid positioning projection is beveled in the region of its free end. In this way, said positioning projection additionally has a self-centering action which is advantageous, for example in the case of a wall element constructed as a door, since it makes it possible for a lightly suspended door to assume its correct position again on being closed. Under these circumstances, the beveled positioning projection acts like a ramp which guides the door into the desired position on being closed.

In preferred designs of the corner reinforcement insert according to the invention, each web is provided with at least one through-bore which extends perpendicularly to the plane of the corner flange and the position of which coincides with a predetermined modular dimension. In a component which has a double-angled edge, there is often present, close to the free edge of said double-angled edge, i.e. on the inner side of the component, a row of holes which has a predetermined modular dimension and which serves for fastening, for example, internal fittings. A row of holes of this kind may not reach right into a corner of the component, particularly in the case of components produced from sheet metal, because a bending tool which is used to produce the double-angled edge has to be removed from the corner region again after the bending operation. By means of the through-bores in the two webs of the corner reinforcement insert, it is possible to neatly supplement or complete a row of holes of this kind.

For the purpose of further improving the sealing action, one or even more sealing ribs may be constructed on outer surfaces of the sheathing part. For example, there may project from said sheathing part, directly at the tip of the corner, a sealing rib which presses, on insertion of the corner reinforcement insert into the corner region, into a small slot, which may in that case be present at that point, in the double-angled edge. Further sealing ribs may be constructed close to such a slot, in order to offer further-increased resistance to the penetration of unwanted environmental influences. Likewise, sealing ribs may be constructed on the upper side and/or underside of the sheathing part in order to achieve the best possible sealing of the corner region.

In some forms of embodiment of the corner reinforcement insert according to the invention, there is located in the region of the plate-shaped corner flange a through-aperture which extends, perpendicularly to the plane of said corner flange, through the base part and the sheathing part. Such a through-aperture may serve, for example, for fastening eyes or hooks to a supporting structure to which the components provided with corner reinforcement inserts according to the invention are attached. If the corner reinforcement insert has such a through-aperture, there is then preferably constructed on the outer surfaces of the sheathing part, around said through-aperture, at least one sealing rib in order to prevent unwanted environmental influences from being able to penetrate into the component via the through-aperture.

For the purpose of simple and secure fitting, there is constructed on the base part, in preferred forms of embodiment of the corner reinforcement insert, at least one spring-tongue-like element, at the free end of which there is arranged a latching pin which extends through the sheathing part and protrudes from it. This latching pin is intended to interact with a latching aperture which is preferably located on the inner side of the component in the corner region into which the corner reinforcement insert is to be inserted. When the desired fitting position is reached, the latching pin snaps into the latching aperture, which, on the one hand, makes it possible to identify that the intended installation position has been reached and, on the other hand, secures the corner reinforcement insert against unintended detachment. There are preferably two spring-tongue-like elements, each having a latching pin. The spring-tongue-like element and the latching pin may be embodied in one piece with the base part.

Basically, any material which is capable of imparting the desired stability to the corner reinforcement insert as a whole is eligible as the material for the base part. For example, said base part may consist of a metal, a hard plastic or even a hard rubber material. Said base part may be embodied as an injection-molded part.

The base part and the sheathing part may be manufactured separately from one another and subsequently connected to one another in order to form a corner reinforcement insert according to the invention. Alternatively, the base part may be produced, together with the sheathing part, as a unit by means of a two-component injection molding process. For that purpose, of course, both the base part and the sheathing part must consist of an injection-moldable material. According to another alternative, the sheathing part may be vulcanized onto, or over-molded onto, the base part.

A preferred exemplary embodiment of a corner reinforcement insert according to the invention will be explained in greater detail below with the aid of the appended diagrammatic drawings, in which:

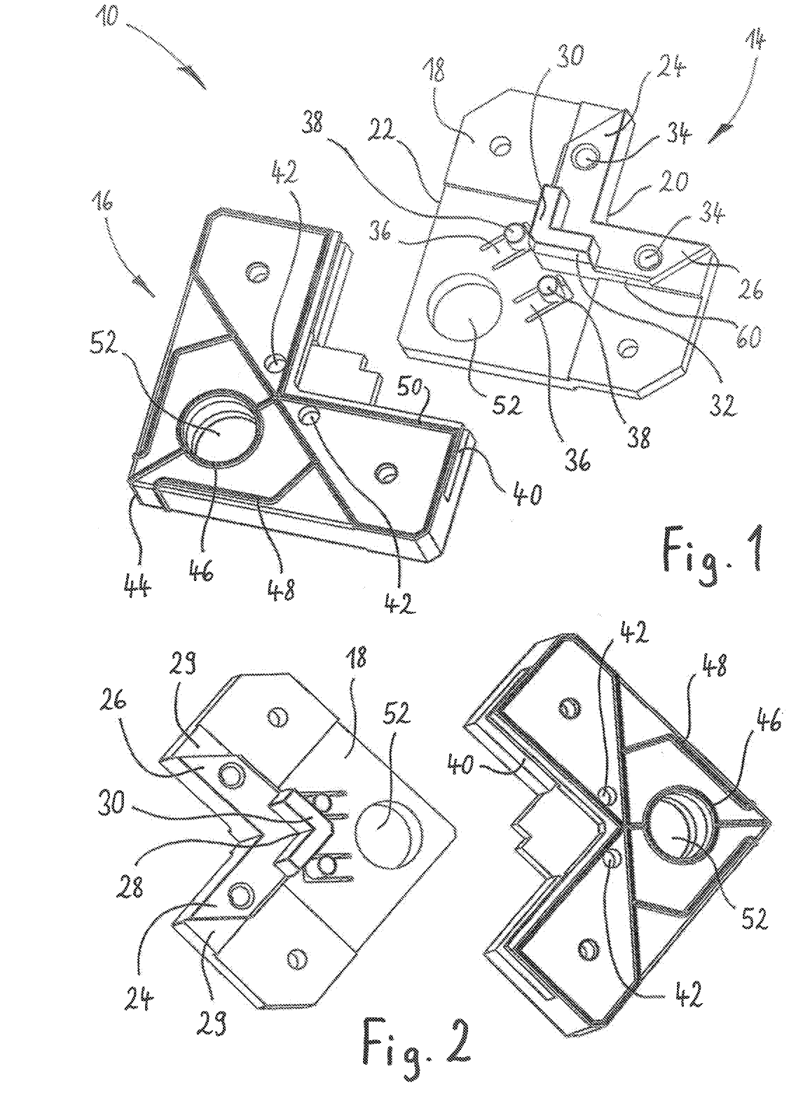

FIG. 1 shows a three-dimensional view, obliquely from above, of a corner reinforcement insert according to the invention, a base part and a sheathing part being represented separately from one another;

FIG. 2 shows another three-dimensional view of the corner reinforcement insert from FIG. 1;

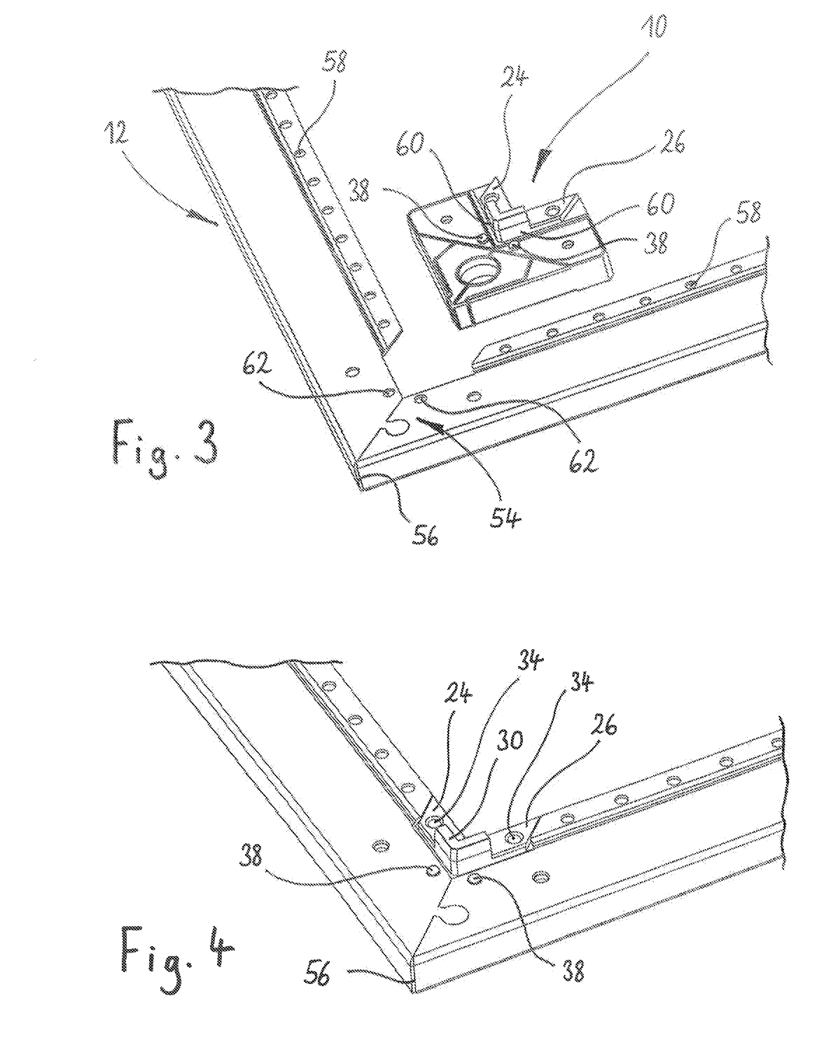

FIG. 3 shows a corner reinforcement insert according to FIG. 1, prior to insertion in a wall element which has a double-angled edge;

FIG. 4 shows a view similar to FIG. 3, but with the corner reinforcement insert inserted in a corner region of the component with the double-angled edge;

FIG. 5 shows a view, which clarifies the function of a positioning projection, of a wall element with the corner reinforcement insert fitted; and

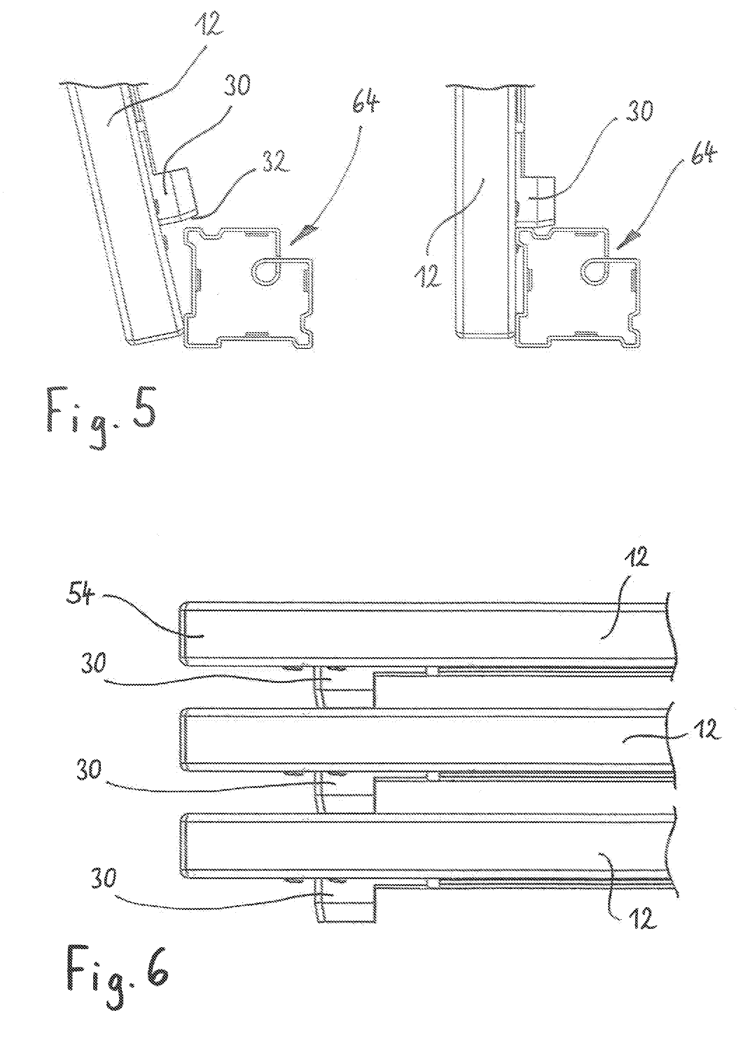

FIG. 6 shows a view of a number of wall elements which are stacked one above another and which are each provided with fitted corner reinforcement inserts.

FIGS. 1 and 2 show, in a three-dimensional view obliquely from above, a corner reinforcement insert which is designated generally by 10 and which is intended for insertion in a corner region 54 of a wall element 12 (see FIG. 3) which has a double-angled edge and is manufactured, for example, from sheet metal. The corner reinforcement insert 10 comprises a base part 14 and a sheathing part 16. In the exemplary embodiment shown, the basic shape of both the base part 14 and the sheathing part 16 is approximately L-shaped, because the corner reinforcement insert 10 shown is intended for insertion in a right-angled corner region. If the corner region in which the corner reinforcement insert is to be inserted is not right-angled, the basic shape of the base part 14 and the sheathing part 16 is adapted, as a rule, to the shape of said corner region. Also, the base part 14 need not necessarily have the same basic shape as the sheathing part 16.

The base part 14 has a plate-shaped corner flange 18, which is arranged at least substantially in one plane and which has an inner circumferential edge 20, which, in this instance, is bent at right angles, and an outer circumferential edge 22 which is likewise bent at right angles in this instance. On the inner circumferential edge 20, a first web 24 and a second web 26 protrude on the upper side of the corner flange 18, perpendicularly to the plane of said corner flange 18, which webs both extend parallel to the inner circumferential edge 20 and are connected to one another at a bending point 28 (see FIG. 2) or merge into one another at that point. The first web 24 is thus located on one side of the bending point 28, while the second web 26 is arranged on the other side of said bending point 28. On the short edge remote from the bending point 28, the webs 24, 26 have oblique clearances 29 (see FIG. 2) which facilitate insertion in the corner region 54.

At the bending point 28, a positioning projection 30, which is L-shaped in this instance, protrudes from the two webs 24, 26 in the same direction as the latter, the function of which projection will be further explained in greater detail later. In the region of its free end, the positioning projection 30 is of beveled construction as shown at 32.

Constructed in each of the webs 24, 26 is a through-bore 34 which extends perpendicularly to the plane of the corner flange 18 and the intended purpose of which will be explained further.

Formed in the plate-shaped corner flange 18 by suitable indentations or clearances are two spring-tongue-like elements 36, at the free ends of which there is arranged, in each case, a latching pin 38 which, in the exemplary embodiment shown, is embodied in one piece with said elements 36 and said corner flange 18. In the exemplary embodiment shown, the two latching pins 38 project in the same direction in which the webs 24, 26 and the positioning projection 30 also project.

The base part 14 is produced from a relatively rigid material which is suitable for the desired purpose of use, for example metal, hard plastic or hard rubber, and forms a core of the corner reinforcement insert 10 which imparts the desired stability to the latter. In the ready-for-insertion condition, the majority of the base part 14, particularly the plate-shaped corner flange 18, is surrounded by the sheathing part 16. In the exemplary embodiment shown, the webs 24, 26 form a stop for the sheathing part 16 and are consequently not surrounded by said sheathing part 16, but lie exposed.

For the purpose of accommodating the corner flange 18, the sheathing part 16 has a correspondingly shaped slot 40 which extends into said sheathing part 16 and into which the corner flange 18 fits completely. Furthermore, the sheathing part 16 is provided, at points which correspond with the latching pins 38, with two apertures 42 through which said latching pins 38 extend and are able to protrude upwards out of said sheathing part 16.

The outer configuration of the sheathing part 16 is adapted to the configuration of the hollow corner region into which the corner reinforcement insert 10 is to be inserted. The sheathing part 16 consists of an elastically flexible material, for example a rubbery-elastic material, and its dimensions are chosen such that it fits into the corner region with little or no clearance. The sheathing part 16 may even have a certain oversize, thereby resulting in a press fit when it is in the condition in which it is inserted in the corner region.

On the outer surfaces of the sheathing part 16, which come into contact with inner surfaces of the double-angled edge when the corner reinforcement insert 10 is inserted in a corner region 54, there are constructed sealing ribs 44, 46, 48 and 50 which bring about increased contact pressure, and thereby still better sealing, along their extent. The sealing ribs 44, 46, 48 and 50 are preferably so arranged that critical regions, for instance the tip of the corner, the edges of the sheathing part 16, etc., are particularly well sealed.

In the exemplary embodiment shown, the corner reinforcement insert 10 is provided, in the region of the plate-shaped corner flange 18, with a through-aperture 52 which extends, perpendicularly to the plane of said corner flange 18, through the base part 14 and the sheathing part 16. In the installed condition, this through-aperture 52 serves to offer access to a carrying structure to which the wall element 12 provided with the corner reinforcement insert or inserts 10 is to be attached. For example, a crane eye (not shown) may be fastened to the carrying structure (not shown) through the aperture 52, in order to lift said carrying structure by means of a crane. In order to prevent the possibility of moisture or other unwanted environmental influences penetrating into the wall element 12 because of the through-aperture 52, a circular sealing rib 46, which completely surrounds said through-aperture 52, is arranged on the upper side and underside, in each case, of the sheathing part 16.

In FIG. 3, the corner reinforcement insert 10 is shown in a condition in which the base part 14 is connected to the sheathing part 16. Also shown in FIG. 3 is a wall element 12 with a corner region 54 which is right-angled in this instance, is open towards the inner side of said wall element 12 and, because of the double-angled edge, is hollow internally, and into which the corner reinforcement insert 10 is to be inserted. Also clearly visible in FIG. 3 is a slot 56 which is produced by cutting to shape and bending over the sheet metal of which the wall element 12 and the double-angled edge consist. Finally, it is possible to make out, in FIG. 3, two rows of holes 58 which are constructed on the inner, free edge of the double-angled edge and which have a predetermined grid of holes and serve to fasten, for example, internal fittings to the wall element 12.

FIG. 4 shows the corner reinforcement insert 10 in its position in which it is completely inserted in the corner region 54. It can be seen that this installation position is defined by lateral faces 60 of the webs 24, 26 coming into contact with the inner, free edges of the double-angled edge of the wall element 12. In this position, the latching pins 38, which are pressed down slightly during the operation of introducing the corner reinforcement insert 10 because of their arrangement on the spring-tongue-like elements 36, snap into latching apertures 62 which are constructed in the inner limbs of the double-angled edge. In this way, the corner reinforcement insert 10 is secured against unintended detachment.

In the installation position reproduced in FIG. 4, the sealing rib 44 is pressed into the slot 56 at the tip of the corner of the corner region 54, and thus reliably seals the said slot. The inner limbs of the double-angled edge and the outer face of the wall element 12, which outer face is arranged on the opposite side and is parallel to said inner limbs, rest on the upper side and lower side, respectively, of the sheathing part 16, as a result of which, on the one hand, the torsional stiffness of the wall element 12 as a whole is enhanced and, on the other hand, penetration of moisture or other unfavorable environmental influences into the corner regions, which are critical in this respect, is prevented.

The way in which the positioning projection 30 facilitates the attachment of a wall element 12 to a supporting structure 64, which is reproduced only in rudimentary form, is represented in FIG. 5. A lower part of the wall element 12 which is to be attached is put onto the supporting structure 64 by means of the positioning projection 30 in the region of the bevel 32 on said positioning projection 30, and then only still needs to be pushed towards said supporting structure 64. The bevel 32 acts as a ramp by means of which the wall element 12 centres itself on the supporting structure 64 in the course of its movement towards the latter. The positioning projection 30 has a similar effect by means of its bevel 32 if the wall element 12 is a door which sags slightly, i.e. hangs downwards slightly, on being opened.

The way in which the positioning projections 30 can serve as spacers when a number of wall elements 12 are stacked on top of one another is represented in FIG. 6.

1. A corner reinforcement insert for wall elements with a double-angled edge, comprising:
a base part including:
a plate-shaped corner flange arranged at least substantially in one plane and having an angled inner circumferential edge and an angled outer circumferential edge; and
a first web and a second web which extend from a same side of the base part on the inner circumferential edge of the corner flange, perpendicularly to a plane of the corner flange and parallel to the inner circumferential edge, wherein the first web is located on a side of a bending point belonging to the inner circumferential edge and the second web is located on the other side of the bending point, and
a corner-shaped sheathing part which comprises a slot configured to accommodate the corner flange and in which the corner flange is arranged in a manner substantially completely surrounded by the sheathing part, wherein the first web and the second web form a stop belonging to the base part for the sheathing part, and wherein the sheathing part consists of an elastomer material and the base part consists of a material which is rigid relative to the sheathing part.

2. The corner reinforcement insert according to claim 1, wherein the first web and the second web are connected to one another at the bending point, and that a positioning projection extends from the webs at the bending point, perpendicularly to the plane of the corner flange.

3. The corner reinforcement insert according to claim 2, wherein the positioning projection is beveled in a region of its free end.

4. The corner reinforcement insert according to claim 1, wherein each web is provided with at least one through-bore which extends perpendicularly to the plane of the corner flange and a position of which coincides with a predetermined modular dimension.

5. The corner reinforcement insert according to claim 1, wherein one or more sealing ribs are constructed on outer surfaces of the sheathing part.

6. The corner reinforcement insert according to claim 1, wherein a through-aperture extends, perpendicularly to the plane of the corner flange, through the base part and the sheathing part in the region of the corner flange, and that a sealing rib is constructed on outer surfaces of the sheathing part, around the through-aperture.

7. The corner reinforcement insert according to claim 1, wherein there is constructed on the base part at least one spring-tongue-like element, at a free end of which there is arranged a latching pin which extends through the sheathing part and protrudes from it.

8. The corner reinforcement insert according to claim 7, wherein the spring-tongue-like element and the latching pin are embodied in one piece with the base part.

9. The corner reinforcement insert according to claim 1, wherein the base part consists of metal, hard plastic or a hard rubber material.

10. The corner reinforcement insert according to claim 1, wherein the base part has been produced, together with the sheathing part, as a unit by a two-component injection moulding process.
